(19) United States
(12) Patent Application Publication
(10) Pub. No.: US 2014/0379704 A1
(43) Pub. Date: Dec. 25, 2014

(54) Method, Apparatus and Computer Program Product for Management of Media Files

(71) Applicant: Nokia Corporation, Espoo (FI)

(72) Inventor: Soumik Ukil, Bangalore (IN)

(73) Assignee: Nokia Corporation, Espoo (FI)

(21) Appl. No.: 14/374,610

(22) PCT Filed: Jan. 23, 2013
(86) PCT No.: PCT/FI2013/050071

§ 371 Date: Jul. 25, 2014

(30) Foreign Application Priority Data
Feb. 20, 2012 (IN) 604/CHE/2012

(51) Int. Cl. G06F 17/30

(52) U.S. Cl. CPC G06F 17/30595; G06F 17/30424
USPC 707/723; 707/736; 707/749

(57) ABSTRACT

Provided herein are a method, apparatus and computer program product for the management of media files, for summarizing groups of media files, and presenting summarized groups of media files to a user. Example methods may include accessing a plurality of media files, obtaining identification of objects within each media file, and determining the minimum set cover of media files from the plurality of media files, where the minimum set cover of media files includes at least one media file comprising each object identified. The method may include determining a weight of each media file, where determining the weight includes analyzing the metadata of each media file. Example methods may also include identifying a dominant set from the plurality of media files, where the dominant set includes at least one dominant media file, and identifying at least one non-dominant media file from the plurality of media files.

### TECHNOLOGICAL FIELD

Example embodiments of the present invention relate generally to a mechanism for management of media files, and more particularly, to a method of identifying a concise group of media files from a larger group of media files.

### BACKGROUND

The modem communications era has brought about a tremendous expansion of wireline and wireless networks. Computer networks, television networks, and telephone networks are experiencing an unprecedented technological expansion, fueled by consumer demand Wireless and mobile networking technologies have addressed consumer demands while providing more flexibility and immediacy of information transfer.

Mobile devices, such as cellular telephones, have become smaller and lighter while also becoming more capable of performing tasks that far exceed a traditional voice call. Mobile devices may be capable of capturing and/or storing many gigabytes of information and objects within a local memory and may be capable of accessing information and objects stored remotely, such as on a network server or found on the Internet. Media files, such as audio and video files may be captured by such mobile devices and such files may contain many gigabytes of information. As cameras, microphones, and software of mobile devices has improved, the quality of captured media files has also increased. The increased quality of media files generally translates to a larger file size.

Some devices may be capable of capturing and uploading files, such as media files, to network services, such as social networking websites. Social networking has promoted the sharing of data files, and in particular, media files; however, due to bandwidth limits, data transfer charges from service providers, and network connection requirements, uploading large quantities of data from a mobile device may be painstaking. Therefore it may be desirable to find methods of reducing the amount of data needed to transfer or upload to a network while still conveying a desirable amount of information.

### SUMMARY

In general, an example embodiment of the present invention provides an improved method, apparatus and computer program product for the management of media files. In particular, embodiments provide an improved mechanism for summarizing groups of media files and methods of presenting summarized groups of media files to a user.

In particular, a method of example embodiments includes accessing a plurality of media files, obtaining identification of objects within each media file, and determining the minimum set cover of media files from the plurality of media files, where the minimum set cover of media files includes at least one media file comprising each object identified. The method may include determining a weight of each media file, where determining the weight includes analyzing the metadata of each media file. Determining the minimum set cover of media files may include using weight as a factor in determining the minimum set cover of media files. The metadata may include social network comments, social network flags, image quality metrics, number of times viewed, etc.

Methods according to example embodiments may also include identifying a dominant set from the plurality of media files, where the dominant set includes at least one dominant media file, and identifying at least one non-dominant media file from the plurality of media files. The at least one dominant media file may include a plurality of dominant media files and the at least one non-dominant media file may include a plurality of non-dominant media files. The method may include providing for display of a media file management system, where moving between dominant media files is performed in response to a first input and moving between non-dominant media files is performed in response to a second input, where the second input is different from the first input. Methods of example embodiments may include providing for display of the at least one dominant media file in a first representation and providing for display of the at least one non-dominant media file in a second representation, where the second representation is depicted as a sub-set of the first representation.

According to another embodiment of the present invention, an apparatus is provided. The apparatus may include at least one processor and at least one memory including computer program code. The at least one memory and the computer program code may be configured to, with the at least one processor, cause the apparatus to access a plurality of media files, obtain identification of objects within each media file, and determine the minimum set cover of media files from the plurality of media files. The minimum set cover of media files may include at least one media file including each object identified. The apparatus may further be caused to determine a weight of each media file, where determining the weight includes analyzing the metadata of each media file. Causing the apparatus to determine the minimum set cover of media files may include causing the apparatus to use weight as a factor in determining the minimum set cover of media files. The metadata may include at least one of social network comments, social network flags, number of viewings, or image quality metrics among others.

The apparatus may optionally be caused to identify a dominant set from the plurality of media files, where the dominant set includes at least one dominant media file, and identify at least one non-dominant media file from the plurality of media files. The at least one dominant media file may include a plurality of dominant media files and the at least one non-dominant media file may include a plurality of non-dominant media files. The apparatus may further be caused to provide for display of a media file management system, where moving between dominant media files is performed in response to a first input and where moving between non-dominant media files is performed in response to a second input, where the second input is different from the first input. The apparatus may further be caused to provide for display of at least one dominant media file in a first representation and provide for display of at least one non-dominant media file in a second representation, where the second representation is depicted as a subset of the first representation.

A further embodiment of the invention may include a computer program product including at least one computer-readable storage medium having computer-executable program code instructions stored therein. The computer executable program code instructions may include program code instructions for accessing a plurality of media files, program code instructions for obtaining identification of objects within each media file, and program code instructions for determining the minimum set cover of media files from the plurality of media files, where the minimum set cover of media files includes at least one media file comprising each object identified. The computer program product may further include program code instructions for determining a weight for each media file, where the program code instructions for determining the weight include program code instructions for analyzing the metadata of each media file. The program code instructions for determining the minimum set cover of media files may include using the weight of the media files as a factor in determining the minimum set cover of media files. The metadata may include at least one of social network comment, social network flags, or image quality metrics.

The computer program product may optionally include program code instructions for identifying a dominant set from the plurality of media files, where the dominant set includes at least one dominant media file, and program code instructions for identifying at least one non-dominant media file from the plurality of media files. The at least one dominant media file may include a plurality of dominant media files and the at least one non-dominant media file may include a plurality of non-dominant media files. The computer program product may further include program code instructions for providing for display of a media file management system, where moving between dominant media files may be performed in response to a first input, and where moving between non-dominant media files may be performed in response to a second input that is different than the first input.

According to another embodiment of the present invention, an apparatus is provided. The apparatus may include means to access a plurality of media files, means to obtain identification of objects within each media file, and means to determine the minimum set cover of media files from the plurality of media files. The minimum set cover of media files may include at least one media file including each object identified. The apparatus may include means to determine a weight of each media file, where determining the weight includes analyzing the metadata of each media file. The means to determine the minimum set cover of media files may include means to use weight as a factor in determining the minimum set cover of media files. The metadata may include at least one of social network comments, social network flags, number of viewings, or image quality metrics among others.

The apparatus may optionally include means to identify a dominant set from the plurality of media files, where the dominant set includes at least one dominant media file, and identify at least one non-dominant media file from the plurality of media files. The at least one dominant media file may include a plurality of dominant media files and the at least one non-dominant media file may include a plurality of non-dominant media files. The apparatus may further include means to provide for display of a media file management system, where moving between dominant media files is performed in response to a first input and where moving between non-dominant media files is performed in response to a second input, where the second input is different from the first input. The apparatus may further include means to provide for display of at least one dominant media file in a first representation and provide for display of at least one non-dominant media file in a second representation, where the second representation is depicted as a subset of the first representation.

### BRIEF DESCRIPTION OF THE DRAWINGS

Having thus described certain example embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing a mechanism for the management of media files according to an example embodiment of the present invention;

FIG. 3 is an illustration of a minimum set cover solution to a group of sets according to an example embodiment of the present invention;

FIG. 4 is an illustration of a dominant set of a dominant graph according to an example embodiment of the present invention;

FIG. 5 is an illustration of a minimum dominant set of a dominant graph according to another example embodiment of the present invention;

FIG. 6 is an illustration of dominant graph according to another example embodiment of the present invention;

FIG. 7 is an illustration of a media file management system for a device according to an example embodiment of the present invention; and

FIG. 8 is flowchart of a system for media file management according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Enhancing or otherwise improving the user experience of a device by improving and simplifying the management of data and files is a constant goal of device designers and manufacturers. Given the ubiquity of media files, such as audio, video, and images that are captured and/or played back on devices and the vast storage capacity of devices, management of media files has become a particular focus for user interaction improvement. The ability to provide an easier and more user-friendly media file management mechanism can be a highly determinative factor in creating marketing awareness to sell products and in creating customer loyalty and satisfaction. Providing a simplified media file management method requiring a lower level of user input may be considered to provide a better user experience. Said differently, users often prefer interaction that is automatic or appears to be as automatic as possible.

Media file management can be particularly tedious for users when there is a large volume of media files stored on their device or otherwise managed by their device. Management of these files can be embodied as classifying media files, tagging (e.g., identifying) individuals or objects contained within the media files, uploading media files to a shared service, such as a social networking website or shared file repository (e.g., Flickr®, Shutterfly®, etc.), or otherwise arranging or accessing media files.

The tagging or identification of individuals or objects within a media file may include associating a person or thing with the media file. For example in a photo image of three people, each of the three people in the photo image may be “tagged” or identified in the photo such that someone viewing the photo may see who is in the photo by the tags of the photo. Optionally, the “tags” or identification of the people in the photo may be added or including in the metadata of the photo image as will be further described below. People or objects may be tagged in any media file, such as an audio, video, or image file.

Metadata is data associated with a file and may contain information about the file. For example, in an audio media file, the metadata may include a song title, an album title, an artist, a length of the audio file, a user rating of the audio file, a genre, sound quality parameters (e.g., mono, stereo, bitrate, etc.), or any information relating to the audio file. Similarly, metadata for an image may include a file size (e.g., height and width in pixels, file data size, etc.), people or things tagged in the image (e.g., a list of people, objects, places, or a combination thereof), a time stamp of when the image was created or modified, a physical location of where the image was created or captured (e.g., GPS coordinates, city, longitude/latitude, etc.), image quality, or information about the device used to capture the image, among many other items of information. Video media files may also have metadata containing any of the above mentioned pieces of information relating to the video file to which the metadata is related.

To provide users with an easy and improved interaction experience for the management of media files, information regarding the media files, such as metadata, may be used to organize, arrange, access, or otherwise provide interaction with the media files.

Some example embodiments of the present invention may provide an improved mechanism for media file management. Organizing and identifying media files may be performed by identifying objects within each media file and determining the minimum set cover of media files from a plurality of media files, where the minimum set cover of media files contains at least one of each object identified, as further detailed below. Additionally or alternatively, a minimum dominating set of media files may be generated from the plurality of media files, where the minimum dominating set of media files includes at least one dominant media file and at least one non-dominant media file.

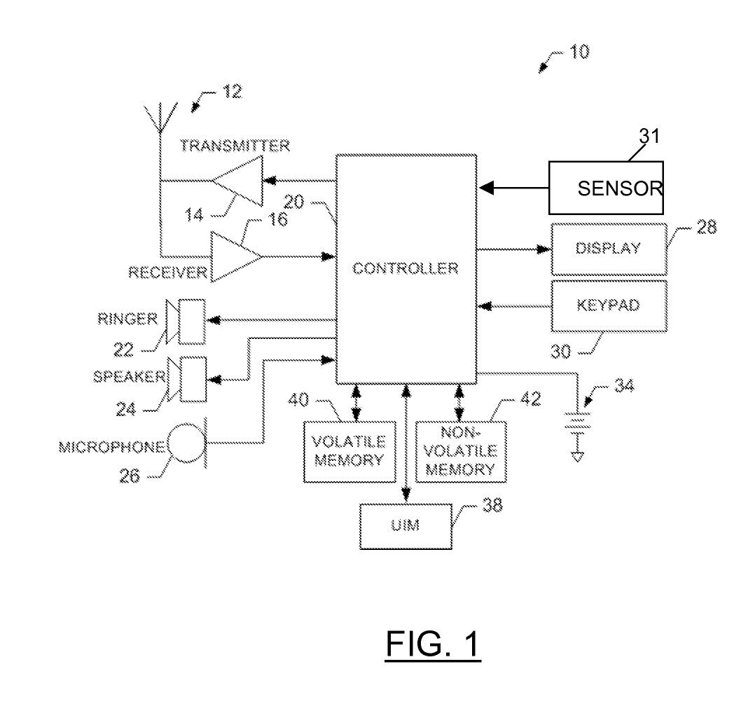

FIG. 1 illustrates one example embodiment of the invention including a block diagram of a mobile terminal 10 that may benefit from embodiments of the present invention. It should be understood, however, that a mobile terminal as illustrated and hereinafter described is merely illustrative of one type of device that may benefit from embodiments of the present invention and, therefore, should not be taken to limit the scope of embodiments of the present invention. While several embodiments of the mobile terminal 10 may be illustrated and hereinafter described for purposes of example, other types of mobile terminals, such as portable digital assistants (PDAs), pagers, mobile televisions, gaming devices, all types of computers (e.g., laptops or mobile computers), cameras, audio/video players, radio, global positioning system (GPS) devices, or any combination of the aforementioned, and other types of communications systems, may readily employ embodiments of the present invention. Even fixed devices may employ some example embodiments.

The mobile terminal 10 may include an antenna 12 (or multiple antennas) in operable communication with a transmitter 14 and a receiver 16. The mobile terminal 10 may further include an apparatus, such as a controller 20 or other processing hardware that controls the provision of signals to and the reception of signals from the transmitter 14 and receiver 16, respectively. The signals may include signaling information in accordance with the air interface standard of the applicable cellular system, and/or may also include data corresponding to user speech, received data and/or user generated data. In this regard, the mobile terminal 10 may be capable of operating with one or more air interface standards, communication protocols, modulation types, and access types. By way of illustration, the mobile terminal 10 may be capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as E-UTRAN (evolved- universal terrestrial radio access network), with fourth-generation (4G) wireless communication protocols or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

It is understood that the apparatus, such as the controller 20, may include circuitry implementing, among others, audio and logic functions of the mobile terminal 10. For example, the controller 20 may comprise a digital signal processor device, a microprocessor device, and various analog to digital converters, digital to analog converters, and/or other hardware support circuits. Control and signal processing functions of the mobile terminal 10 are allocated between these devices according to their respective capabilities. The controller 20 thus may also include the functionality to convolutionally encode and interleave message and data prior to modulation and transmission. The controller 20 may additionally include an internal voice coder, and may include an internal data modem. Further, the controller 20 may include functionality to operate one or more software programs, which may be stored in memory. For example, the controller 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as an earphone or speaker 24, a ringer 22, a microphone 26, a display 28, and a user input interface, which may be coupled to the controller 20. The user input interface, which allows the mobile terminal 10 to receive data, may include any of a number of devices allowing the mobile terminal 10 to receive data, such as a keypad 30, a touch display (not shown), a microphone 26 or other input device. In embodiments including the keypad 30, the keypad 30 may include numeric (0-9) and related keys (#, *), and other hard and soft keys used for operating the mobile terminal 10. Alternatively, the keypad 30 may include a conventional QWERTY keypad arrangement. The keypad 30 may also include various soft keys with associated functions. In addition, or alternatively, the mobile terminal 10 may include an interface device such as a joystick or other user input interface. The mobile terminal 10 further includes a battery 34, such as a vibrating battery pack, for powering various circuits that are used to operate the mobile terminal 10, as well as optionally providing mechanical vibration as a detectable output.

The mobile terminal 10 may further include a user identity module (UIM) 38, which may generically be referred to as a smart card. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), or any other smart card. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The non-volatile memory 42 may additionally or alternatively comprise an electrically erasable programmable read only memory (EEPROM), flash memory or the like. The memories may store any of a number of pieces of information, and data, used by the mobile terminal 10 to implement the functions of the mobile terminal 10.

In some embodiments, the mobile terminal 10 may also include a camera or other media capturing element (not shown) in order to capture images or video of objects, people and places proximate to the user of the mobile terminal 10. However, the mobile terminal 10 (or even some other fixed terminal) may also practice example embodiments in connection with images or video content (among other types of content) that are produced or generated elsewhere, but are available for consumption at the mobile terminal 10 (or fixed terminal).

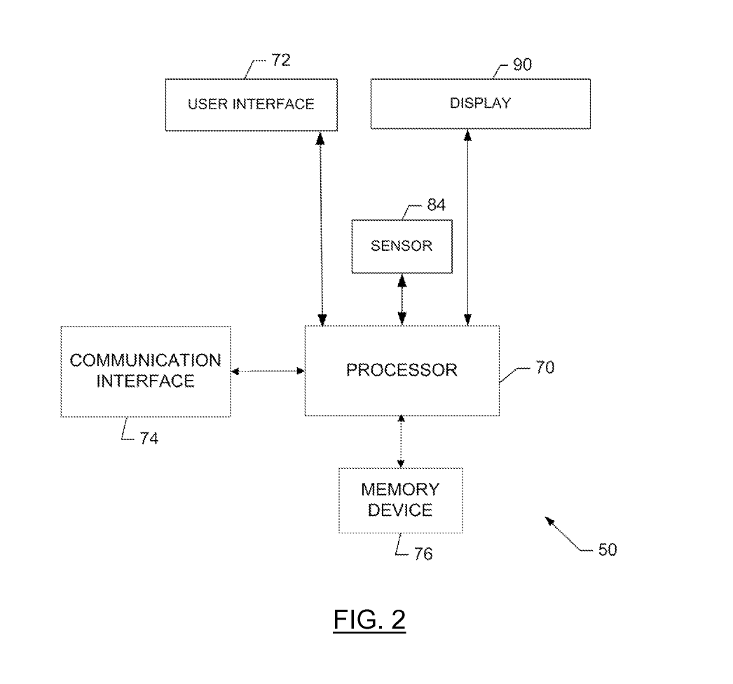

An example embodiment of the invention will now be described with reference to FIG. 2, in which certain elements of an apparatus 50 for providing a mechanism by which a device may be synchronized with other devices for a collaboration application. The apparatus 50 of FIG. 2 may be employed, for example, in conjunction with the mobile terminal 10 of FIG. 1. The user interface 72 of FIG. 2 may include one or more of the display 28 and keypad 30 of the mobile terminal of FIG. 1. The apparatus may further include one or more sensors 84 such as sensor 31 of FIG. 1. The processor 70 of FIG. 2 may be embodied in the processor 20 of FIG. 1 and the communications interface 72 may include the transmitter 14, receiver 16, and antenna 12 of the mobile terminal 10. However, it should be noted that the apparatus 50 of FIG. 2, may also be employed in connection with a variety of other devices, both mobile and fixed, and therefore, embodiments of the present invention should not be limited to application on devices such as the mobile terminal 10 of FIG. 1.

It should also be noted that while FIG. 2 illustrates one example of a configuration of an apparatus for providing a mechanism by which a device may manage media files, numerous other configurations may also be used to implement embodiments of the present invention. As such, in some embodiments, although devices or elements are shown as being in communication with each other, hereinafter such devices or elements should be considered to be capable of being embodied within the same device or element and thus, devices or elements shown in communication should be understood to alternatively be portions of the same device or element.

Referring again to FIG. 2, the apparatus 50 for providing a mechanism by which a device may manage media files is provided and may include or otherwise be in communication with a processor 70, a user interface 72, a communication interface 74 and a memory device 76. In some embodiments, the processor 70 (and/or co-processors or any other processing circuitry assisting or otherwise associated with the processor 70) may be in communication with the memory device 76 via a bus for passing information among components of the apparatus 50. The memory device 76 may include, for example, one or more volatile and/or non-volatile memories. In other words, for example, the memory device 76 may be an electronic storage device (e.g., a computer readable storage medium) comprising gates configured to store data (e.g., bits) that may be retrievable by a machine (e.g., a computing device like the processor 70). The memory device 76 may be configured to store information, data, applications, instructions or the like for enabling the apparatus to carry out various functions in accordance with an example embodiment of the present invention. For example, the memory device 76 could be configured to buffer input data for processing by the processor 70. Additionally or alternatively, the memory device 76 could be configured to store instructions for execution by the processor 70.

The apparatus 50 may, in some embodiments, be a mobile terminal (e.g., mobile terminal 10) or a computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen(s), touch areas, device surfaces capable of detecting objects hovering over the surface, soft keys, a microphone, a speaker, motion sensor, temperature sensor, accelerometer, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

Example embodiments of the invention may provide a mechanism by which media files are managed in an easier and more efficient manner than previously available. Embodiments of the invention may summarize a group of media files in a number of media files that is less than the number of media files in the group, while each identified item or object of interest is represented in at least one media file within the summarized group of media files.

With the proliferation of digital cameras and devices equipped with cameras and/or microphones, the amount of data captured through media files such as images and video has exploded. Although the storage capacity of devices has also increased, the increased volume of media files has presented challenges for media file management and retrieval. Further, as the advent of digital photography has eliminated the incremental cost of taking pictures, digital pictures are often taken in abundance, more indiscriminately, with many pictures appearing to be duplicates or containing much of the same subject matter.

Example embodiments of the present invention may provide efficient algorithms for managing and summarizing groups of media files to enable faster, more efficient review of media files and to provide a more compressed representation of a group of media files that may still retain the salient properties of the group of media files. Example embodiments may provide a technique for summarizing a group of media files, such as a group of pictures, from social gatherings, parties, or other events where images may typically consist of a closed set of multiple people. In order to find the most representative subset of images for the summary, the summarization problem may be framed as a minimum set cover problem which can be solved efficiently using a variety of approximation algorithms.

In an example embodiment, a group of images of a social gathering includes images of a number of people taken in a similar time and location. A summary of the group of images may be desirable to represent the social gathering in a more concise, smaller group of images. The objective may include finding the minimum number of images that cover all of the objects of interest in the group of images. In the present example, the objects of interest may include people; however, the objects of interest may be any identifiable object in the image, such as a landmark, an animal, a plant, or any identifiable object. The group of images may contain multiple occurrences of one or more of the objects of interest; however, the summarized group of images may be the smallest group of images that contains at least one occurrence of each object of interest. In the instant embodiment, the summarized group of images would be the smallest number of images that include at least one picture containing each person at the social gathering. Such a summary may be generated using the set cover problem.

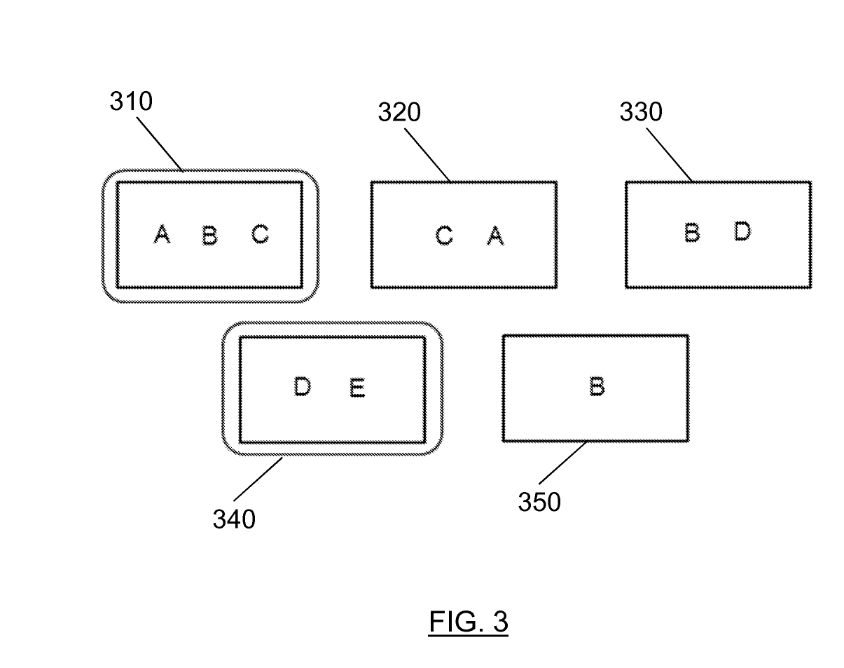

The set cover problem is a question in complexity theory. Given a set of m elements, known as the universe, and n sets whose union comprises the universe, the set cover problem is to identify the smallest number of sets whose union still contains all of the elements in the universe. FIG. 3 is an example embodiment of the set cover problem in which the minimum set cover is identified. The illustrated embodiment includes the set of elements, or universe {A, B, C, D, E} and sets 310, 320, 330, 340, and 350 whose union includes the universe (e.g., 310-350 include A, B, C, D, and E). The set cover problem identifies the smallest number of sets that will still include the universe. In the example embodiment of FIG. 3, that minimum set cover includes 310 and 340 as between 310 and 340, each of A, B, C, D, and E are represented. Example embodiments of the present invention may use the set cover problem to create a summary (e.g., a minimum set cover) of a group of media files.

Objects of interest may be identified within a media file in a number of ways. For example, objects of interest in a group of media files may be individual people in a group of images. The individual people within the group of images may be identified in each image in a number of ways. Individuals may be tagged, where the portion of an image featuring an individual is associated with the individual, for example by name. The individual may be tagged manually, such as by a person selecting the portion of the image featuring the person and manually associating the person's name, or the tagging may be performed automatically, for example by facial recognition as described further below. Further, as groups of images may be from a single event, location, or time, an example of each person may be tagged and each instance of that individual throughout the group may be automatically tagged by software associating similar image features with each individual person, such as a color of clothing or a hat worn by a particular person.

Objects of interest may be included in the metadata of a media file. For example a picture may include a list of individuals found within the picture in the metadata. The particular areas of the image that include those people may or may not be included in the metadata. Other objects of interest, such as landmarks or any distinct object may be tagged or otherwise associated with the media file and may be included in the metadata. While the example embodiment describes an image file containing people, other embodiments may include an audio file containing voices belonging to different individuals, an audio file containing a composer or musician, a video file containing a person, an image file containing an inanimate object, or any media file containing any identifiable object associated with the media file.

Facial recognition, and unsupervised clustering of similar faces (e.g., automatic facial recognition and association) may include an additional parameter such that no two faces in an image can belong to the same person. Such a parameter ensures that no two faces in an image are assigned the same identity, which is critical to the formulation of the set cover problem. The clustering algorithm may be ensured by setting all distances between faces in the same image to be an arbitrary value. Such an algorithm may ensure that faces are assigned individual identities.

While tagging of objects within a media file have been described with respect to example embodiments of the present invention, the actual identity of an object does not necessarily need to be known. For example, in the case of facial recognition tagging, an unidentified face may be assigned a pseudonym to ensure that face is recognized throughout a group of images as the same face, despite the identity of the person not being known. A similar pseudonym may be assigned to any discrete object for which the identity may not be known or is unassigned.

While the set cover problem may be capable of producing a summary of a group of media files, where each identified object is represented in at least one of the media files, additional parameters may be implemented by algorithms to improve the quality of a summary of a group of media files. For example, media files within the group may include a weight which correlates to a quality of a media file. The weight may be determined by a number of factors, including such factors as media file quality (e.g., image quality, video quality, audio file quality, etc.), the popularity of a media file (e.g., the number of views, comments, or ‘likes’ established on a system sharing the file, such as a social networking site), the time that a media file was created (e.g., a more recent file may be of a higher weight), etc. Each of these factors may be considered in determining a weight for a media file. In this manner, an algorithm to establish the minimum set cover may include the weight of a media file when determining the minimum set cover from the group of media files. The importance of each factor included in the determination of the weight, or the importance of media file weight in establishing the minimum set cover may be user configurable in order to tailor summaries of groups of media files for a particular user. For example, a user may want a summary of a group of image files that includes only high quality images such that the weight afforded an “image quality” metric may be increased and significantly affect the set cover problem algorithm that establishes the summary through the minimum set cover. Optionally, a user may consider how recently an image was captured to be an important factor in developing a summary of the images. Therefore, the time-of-creation of an image file may affect the weight afforded an image in the minimum set cover algorithm.

Through the set cover problem, a concise summary of media files may be developed that includes all of the identified objects of interest. This concise summary may be more appropriate for uploading to a social networking site than the entire group of pictures from which the summary was developed. For example, if 300 images were captured from various sources at a wedding, where 100 people were in attendance and each was in at least one image, applying the set cover problem to the group of 300 images may summarize the group in 35 images, for example. Within the 35 images, at least one occurrence of each individual may be found. The 35 images may be reproduced, uploaded, or otherwise distributed such that all 100 people in attendance may be shown in a concise group of images without having to review all 300 images.

While embodiments of the invention have been described with respect to creating a summary of a group of media files, further example embodiments of the invention may provide a mechanism for faster, easier, and more efficient review of a group of media files. Objects of interest within a media file may be used to create a dominating set and linking media files together.

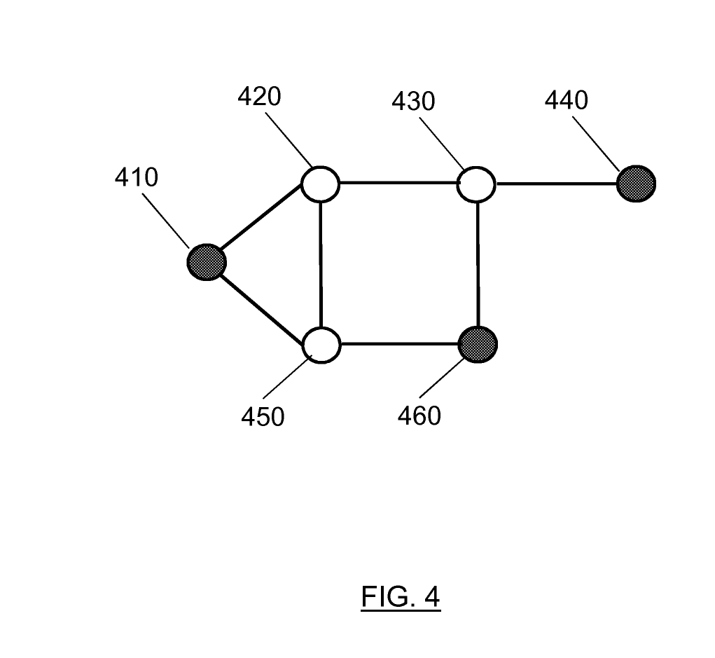

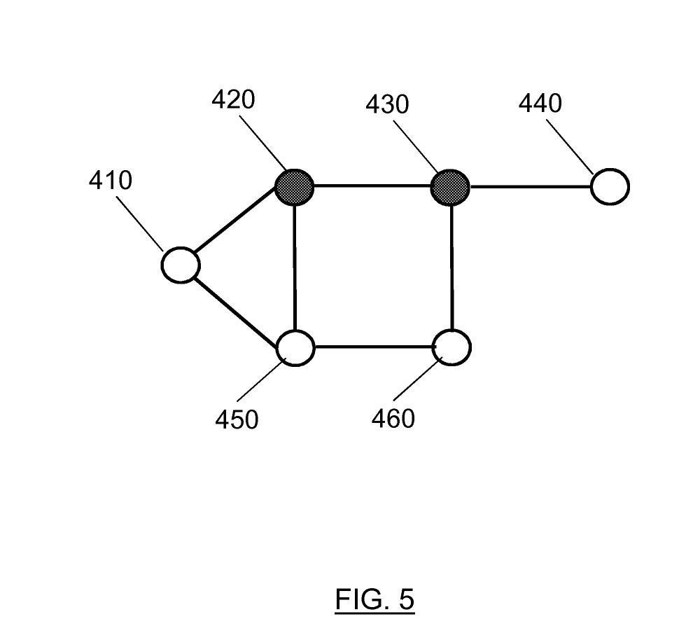

The dominating set is a graph theory where points of the graph are correlated to one another through relationships that are established. In the instant embodiment, the relationships may be common objects of interest. For example, two images, each including a particular object of interest, may be linked together in the dominating set graph. FIG. 4 illustrates an example embodiment of a dominating set graph. In the illustrated embodiment, each hollow node (420, 430, 450) is adjacent to at least one solid node (410, 440, 460). Every hollow node must be jointed to at least one solid node by a vertex. The “domination number” is the number of nodes in a smallest dominating set. In this manner, the dominating set is similar to the set cover problem. The dominating set is established by determining the minimum number of nodes in a dominant set that are required to ensure each other node is connected to at least one node from the dominant set. In the illustration of FIG. 4, the dominant set shown is not the minimum dominant set. FIG. 5 illustrates one example of the minimum dominant set of the example of FIG. 4. Each node in the illustrated embodiment may be connected to a node of the dominant set even when only two nodes are in the dominant set. As FIG. 5 illustrates one version of the minimum dominant set, the domination number of this graph is two. An alternative minimum dominant set for the illustrated embodiment may include node 450 and node 430.

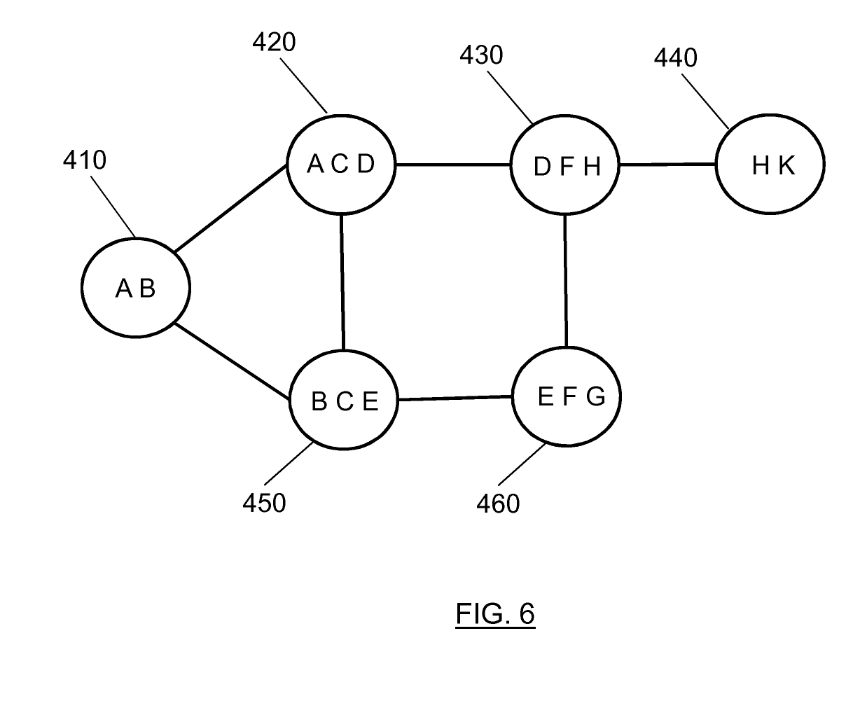

To draw a correlation to an example embodiment, the nodes of FIG. 6 may each represent an image file containing people. The people include A, B, C, D, E, F, G, H, and K. The set is the group of images and includes images 410, 420, 430, 440, 450, and 460. The connections between the nodes represent a common person found in each image or node connected. For example, images 420 and 450 are connected to node 410 as 410 and 420 include person A while image 410 and 450 each include person B. Images 450 and 420 are connected because each includes person C. Images or nodes 430 and 410 are not connected to one another as they do not contain a common person. In the illustrated embodiment, the minimum dominant set may be determined. The dominant set may include images 450 and 430 as each other node or image in the graph is connected to at least one of 450 and 430. While the dominant set may not include an image containing every person in the group of images, an image containing each individual is no more than one image away from the dominant set.

The illustrated embodiment of FIG. 6 is relatively simple with few connections between nodes; however, dominant set graphs may become very complex with large numbers of objects of interest, large numbers of media files, and greater overlap of content between media files. Such dominant set graphs may be difficult to illustrate on a two-dimensional rendering.

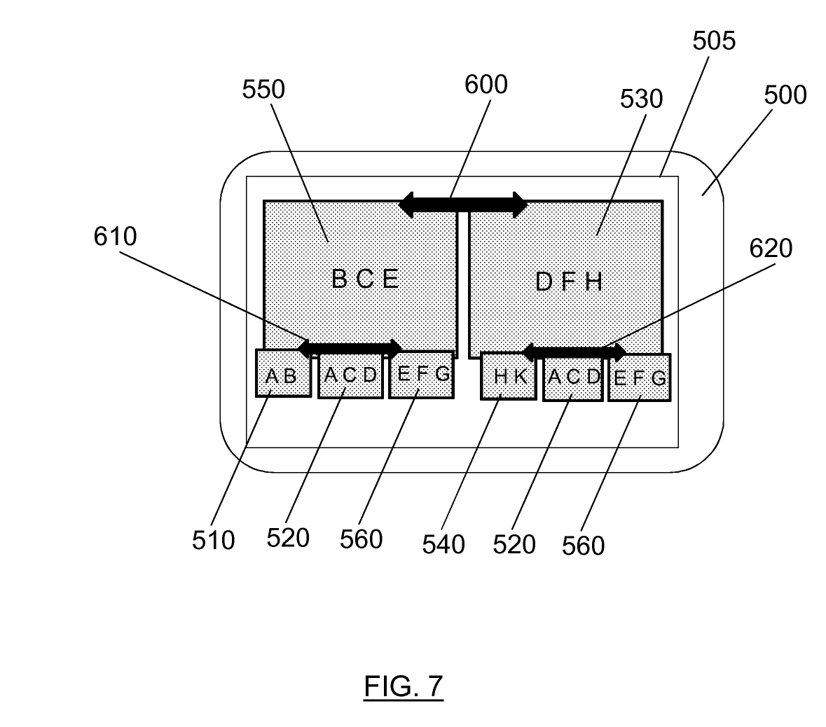

The minimum dominant set may be used to establish a mechanism for media file management where the dominant set is used as a high-level of images through which all other images may be accessed. For example, FIG. 7 illustrates a graphical representation of a media file management system on the display 505 of a device 500 using the minimum dominant set. The minimum dominant set may be represented with larger, more prominent images, such as images 550 and 530 which represent nodes or images 450 and 430 of FIG. 6, respectively. The other images may be depicted below the dominant set image to which they are connected. For example as nodes 410, 420, and 430 are connected to dominant node 450, images 510, 520, and 530 are depicted as a sub-set of the dominant image 550. Image 520 containing people A C and D is common to both dominant images 550 and 530 such that image 520 is depicted in the subset of both images 550 and 530.

A mechanism for navigating between media files may also be provided which uses the dominant set. Arrow 600 illustrates an option to scroll between dominant images or media files within the group of media files. The illustrated arrow 600 may or may not be present, but is illustrated to demonstrate how a user may use a touch screen or other input to scroll between dominant media files. Similarly, arrows 610 and 620 illustrate an option to scroll among the non-dominant media files of the subsets of image 550 and 530. While the illustrated embodiment does not include images beyond those featured on the display 505, it is appreciated that groups of media files that include additional media files may be displayed in a similar manner with some images only accessible to a user through scrolling or panning as the display may not be large enough to present all of the images simultaneously.

As described above with respect to the set cover problem, the minimum dominant set may factor the weight of a media file into the algorithm to determine the minimum dominant set. For example, there are more than one option for the minimum dominant set of FIG. 5 such that the weight of each node (or media file) may be considered when determining which minimum dominant set to use. If a media file includes a higher weight based upon a desirable characteristic of the media file (e.g., quality, age, number of objects of interest, number of comments or views, etc.), then the media file with the higher weight may be selected over the media file with the lower weight.

While the example embodiments of management of media files have been described separately with regard to use of the set cover problem technique for creating a summary of a group of media files and the minimum dominant set for creating a summary of a group of media files, the two embodiments may be used in concert to create a visual interaction with a group of media files that provides a visual cue of the relationship between media files within the group.

In an example embodiment, the set cover problem may be applied to a group of media files to develop the minimum set cover, which includes a summary of the group of media files. The summary of the group of media files contains media files which include at least one representation of each object of interest identified. The minimum set cover or summary of the group of media files may be made the dominant set in a dominant set graph, such that all of the media files are connected to media files that include common objects of interest. As the minimum dominant set may not include at least one representation of each object of interest within the media files of the minimum dominant set, using the minimum set cover as the dominant set may provide a mechanism to view at least one media file that includes each of the objects of interest in a dominant set while depicting media files not included in the minimum set cover as non-dominant media files.

Such an example embodiment of combining the minimum set cover with the dominant set presentation of media files may allow a user to quickly view the summary of the group of media files quickly. Further, upon viewing a media file (or listening to a media file as the case may be), the user may delve into the media files connected to the dominant media file to view related media files. For example if a user is viewing images from a wedding, the user may view the dominant images as depicted in FIG. 7. Upon seeing a first image including a person that the user wishes to see more of, the user may then scroll or otherwise peruse the images connected to that first image by scrolling through the thumbnails (depicted as 510, 520, 560 in FIG. 7).

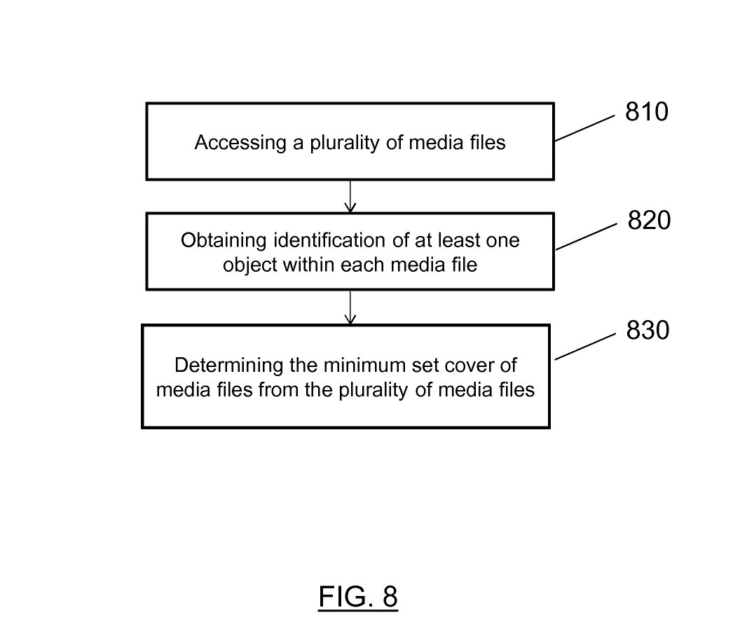

FIG. 8 is a flowchart of a method and program product according to an example embodiment of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user terminal or other device and executed by a processor in the user terminal or other device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 8, may include accessing a plurality of media files at 810, obtaining identification of at least one object within each media file at 820, and determining the minimum set cover of media files from the plurality of media files, where the minimum set cover of media files includes at least one media file comprising each object identified at 830.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. In some embodiments, the method may include determining a weight of each media file, where determining the weight includes analyzing the metadata of each media file. Determining the minimum set cover of media files may include using the weight as a factor in determining the minimum set cover of media files. The metadata may include at least one of social network comments, social network flags, or image quality metrics. The method of some embodiments may include identifying a dominant set from the plurality of media files, where the dominant set includes at least one dominant media file, and identifying at least one non-dominant media file from the plurality of media files. Methods may further include where the at least one dominant media file includes a plurality of dominant media files and the at least one non-dominant media file includes a plurality of non-dominant media files, the method including providing for display of a media file management system, where moving between dominant media files is performed in response to a first input and where moving between non-dominant media files is performed in response to a second input that is different from the first input. Methods of example embodiments may include where the at least one dominant media file is displayed in a first representation and the at least one non-dominant media file is displayed in a second representation that id depicted as a sub-set of the first representation.

In an example embodiment, an apparatus for performing the method of FIG. 8 above may comprise a processor (e.g., the processor 70) configured to perform some or each of the operations (810-830) described above. The processor may, for example, be configured to perform the operations (810-830) by performing hardware implemented logical functions, executing stored instructions, or executing algorithms for performing each of the operations. Alternatively, the apparatus may comprise means for performing each of the operations described above. In this regard, according to an example embodiment, examples of means for performing operations 810-830 may comprise, for example, the processor 70. Additionally or alternatively, at least by virtue of the fact that the processor 70 may be configured to control or even be embodied as the processor 70, and/or a device or circuitry for executing instructions or executing an algorithm for processing information as described above may also form example means for performing operations 810-830.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1-28. (canceled)

29. A method comprising:
accessing a plurality of media files;
obtaining identification of objects within each media file; and
determining the minimum set cover of media files from the plurality of media files, wherein the minimum set cover of media files includes at least one media file comprising each object identified.

30. The method of claim 29, further comprising determining a weight of each media file, wherein determining the weight comprises analyzing the metadata of each media file.

31. The method of claim 30, wherein determining the minimum set cover of media files comprises using weight as a factor in determining the minimum set cover of media files.

32. The method of claim 30, wherein the metadata comprises at least one of social network comments, social network flags, number of viewings, or image quality metrics.

33. The method of claim 29, further comprising:
identifying a dominant set from the plurality of media files, wherein the dominant set comprises at least one dominant media file; and
identifying at least one non-dominant media file from the plurality of media files.

34. The method of claim 33, wherein the at least one dominant media file comprises a plurality of dominant media files, wherein the at least one non-dominant media file comprises a plurality of non-dominant media files, and further comprising:
providing for display of a media file management system, wherein moving between dominant media files is performed in response to a first input, and wherein moving between non-dominant media files is performed in response to a second input, wherein the second input is different from the first input.

35. The method of claim 33, further comprising:
providing for display of the at least one dominant media file in a first representation; and
providing for display the at least one non-dominant media file in a second representation;
wherein the second representation is depicted as a sub-set of the first representation.

36. An apparatus comprising at least one processor and at least one memory including computer program code, the at least one memory and the computer program code configured to, with the at least one processor, cause the apparatus to:
access a plurality of media files;
obtain identification of objects within each media file; and
determine the minimum set cover of media files from the plurality of media files, wherein the minimum set cover of media files includes at least one media file comprising each object identified.

37. The apparatus of claim 36, wherein the apparatus is further caused to determine a weight of each media file, wherein determining the weight comprises analyzing the metadata of each media file.

38. The apparatus of claim 37, causing the apparatus to determine the minimum set cover of media files comprises causing the apparatus to use weight as a factor in determining the minimum set cover of media files.

39. The apparatus of claim 36, wherein the metadata comprises at least one of social network comments, social network flags, number of viewings, or image quality metrics.

40. The apparatus of claim 36, wherein the apparatus is further caused to:
identify a dominant set from the plurality of media files, wherein the dominant set comprises at least one dominant media file; and
identify at least one non-dominant media file from the plurality of media files.

41. The apparatus of claim 40, wherein the at least one dominant media file comprises a plurality of dominant media files, wherein the at least one non-dominant media file comprises a plurality of non-dominant media files, and the apparatus further caused to:
provide for display of a media file management system, wherein moving between dominant media files is performed in response to a first input, and wherein moving between non-dominant media files is performed in response to a second input, wherein the second input is different from the first input.

42. The apparatus of claim 40, wherein the apparatus is further caused to:
provide for display of the at least one dominant media file in a first representation; and
provide for display the at least one non-dominant media file in a second representation;
wherein the second representation is depicted as a sub-set of the first representation.

43. A computer program product comprising at least one computer-readable storage medium having computer-executable program code instructions stored therein, the computer-executable program code instructions comprising:
program code instructions for accessing a plurality of media files;
program code instructions for obtaining identification of objects within each media file; and
program code instructions for determining the minimum set cover of media files from the plurality of media files, wherein the minimum set cover of media files includes at least one media file comprising each object identified.

44. The computer program product of claim 43, further comprising program code instructions for determining a weight of each media file, wherein the program code instructions for determining the weight comprise program code instructions for analyzing the metadata of each media file.

45. The computer program product of claim 44, wherein the program code instructions for determining the minimum set cover of media files comprises using weight as a factor in determining the minimum set cover of media files.

46. The computer program product of claim 43, wherein the metadata comprises at least one of social network comments, social network flags, or image quality metrics.

47. The computer program product of claim 43, further comprising:
program code instructions for identifying a dominant set from the plurality of media files, wherein the dominant set comprises at least one dominant media file; and
program code instructions for identifying at least one non-dominant media file from the plurality of media files.

48. The computer program product of claim 47, wherein the at least one dominant media file comprises a plurality of dominant media files, wherein the at least one non-dominant media file comprises a plurality of non-dominant media files, and further comprising:
program code instructions for providing for display of a media file management system, wherein moving between dominant media files is performed in response to a first input, and wherein moving between non-dominant media files is performed in response to a second input, wherein the second input is different from the first input.
